(19) United States
(12) Patent Application Publication
(10) Pub. No.: US 2013/0185769 A1
(43) Pub. Date: Jul. 18, 2013

(54) NEAR FIELD COMMUNICATION ELECTRONIC DEVICE, LOGIN SYSTEM USING THE SAME AND METHOD THEREOF

(71) Applicants: Chia-You Jian, Taipei City (TW); Jung-Hsing Wang, Taipei City (TW); Wen-Shiu Hsu, Taipei City (TW); Hung-Yi Lin, Taipei City (TW)

(72) Inventors: Chia-You Jian, Taipei City (TW); Jung-Hsing Wang, Taipei City (TW); Wen-Shiu Hsu, Taipei City (TW); Hung-Yi Lin, Taipei City (TW)

(73) Assignee: ASUSTeK COMPUTER INC., Taipei City (TW)

(21) Appl. No.: 13/726,649

(22) Filed: Dec. 26, 2012

(30) Foreign Application Priority Data
Jan. 13, 2012 (TW) 101101465

(51) Int. Cl. H04L 29/06

(52) U.S. Cl. CPC H04L 63/08
USPC 726/4

(57) ABSTRACT

A near field communication (NFC) electronic device, a login system using the same and a method thereof are disclosed. The NFC electronic device includes a reading module, an embedded controller and a matching module. The reading module receives identification information transmitted from a readable component when the readable component approaches. The embedded controller is connected to the reading module and stores the identification information. The matching module is connected to the embedded controller and performs a matching authentication according to the identification information. If the matching authentication is successful, the matching module searches whether required account confidential information exists in a database according to the identification information. If yes, the matching module selects and transmits the required account confidential information to the embedded controller. The embedded controller outputs a hardware signal corresponding to the account confidential information to an application program of a user login screen.

### CROSS-REFERENCE TO RELATED APPLICATION

This application claims the priority benefit of Taiwan application serial no. 101101465, filed on Jan. 13, 2012. The entirety of the above-mentioned patent application is hereby incorporated by reference herein and made a part of this specification.

### BACKGROUND OF THE INVENTION

1. Field of the Invention

The invention relates to a login system and, more particularly, to a login system using a near field communication (NFC) electronic device and a login method thereof.

2. Description of the Related Art

Near field communication (NFC) is also called near field wireless communication. It is a high frequency wireless communication technology in a short distance and derived from an integration of non-impact radio frequency identification (RFID) and interconnection technique. The NFC technology permits two electronic devices to execute a point-to-point connection and communication for data exchange and transmission when the two electronic devices approach or contact with each other.

The NFC technology is applied to electronic products such as a smart phone or a tablet computer, and it is convenient for managing and transmitting personal data. A NFC electronic product cooperating with a high reliability secure component can be applied to identity recognition and services such as trade and pay. For example, after identity verification via the NFC technology, users can pay for exchanging data and service.

When the user logins an operation system, a webmail service or various social networking sites via the smart phone or the tablet computer, he or she needs to input different accounts and passwords manually. Moreover, the system or network service providers should provide software corresponding to different operation systems or network services to complete the login process with the NFC technology. It is rather inconvenient.

### BRIEF SUMMARY OF THE INVENTION

A NFC electronic device, a login system using the NFC electronic device and a login method thereof are disclosed.

The NFC electronic device includes a reading module, an embedded controller and a matching module. The reading module receives identification information transmitted from a readable component when the readable component approaches. The embedded controller is connected to the reading module and stores the identification information. The matching module is connected to the embedded controller and performs a matching authentication according to the identification information, if the matching authentication is successful, the matching module searches whether required account confidential information exists in a database according to the identification information, and if yes, the matching module selects and transmits the required account confidential information to the embedded controller. The embedded controller outputs a hardware signal corresponding to the account confidential information to an application program of a user login screen to finish a login process.

A login system includes a readable component and a NFC electronic device. The readable component transmits identification information to a NFC electronic device when the readable component approaches the NFC electronic device. The NFC electronic device further includes a reading module, an embedded controller and a matching module. The reading module receives identification information transmitted from the readable component when the readable component approaches. The embedded controller is connected to the reading module and stores the identification information. The matching module is connected to the embedded controller and performs a matching authentication according to the identification information, if the matching authentication is successful, the matching module searches whether required account confidential information exists in a database according to the identification information, and if yes, the matching module selects and transmits the required account confidential information to the embedded controller. The embedded controller outputs a hardware signal corresponding to the account confidential information to an application program of a user login screen to finish a login process.

A login method applied to a NFC electronic device is disclosed. The login method includes following steps: receiving identification information from a readable component via a reading module and storing the identification information in an embedded controller of the NFC electronic device; performing a matching authentication according to the identification information via a matching module, and if the matching authentication is successful, searching whether required account confidential information exists in a database according to the identification information; selecting the account confidential information and transmitting the account confidential information to the embedded controller via the matching module; and outputting a hardware signal corresponding to the account confidential information to an application program of a user login screen via the embedded controller to finish a login process.

These and other features, aspects and advantages of the present invention will become better understood with regard to the following description, appended claims, and accompanying drawings.

### BRIEF DESCRIPTION OF THE DRAWINGS

FIG. 1A is a block diagram showing a NFC electronic device in a first embodiment.

FIG. 1B is a block diagram showing a login system using a NFC electronic device in a first embodiment.

FIG. 2 is a flow chart showing steps of a login method applied to a NFC electronic device in a first embodiment.

FIG. 3 is a block diagram showing a login system using a NFC electronic device in a second embodiment.

FIG. 4 is a flow chart showing steps of a login method applied to a NFC electronic device in a second embodiment.

### DETAILED DESCRIPTION OF THE EMBODIMENTS

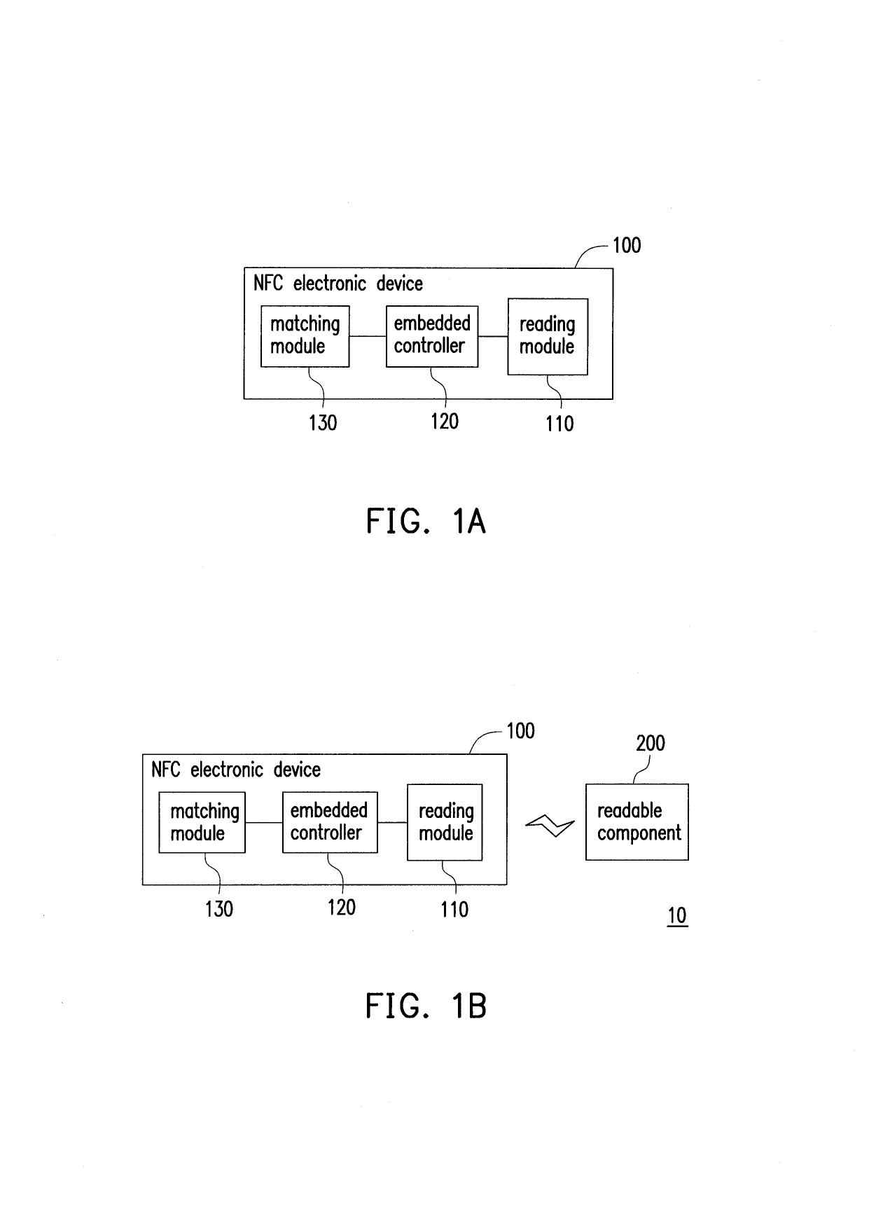

FIG. 1A is a block diagram showing a NFC electronic device in a first embodiment. FIG. 1B is a block diagram showing a login system using a NFC electronic device in a first embodiment. As shown in FIG. 1A and FIG. 1B, a login system 10 includes a NFC electronic device 100 a readable component 200.

The NFC electronic device 100 may be a mobile phone, a smart phone, a computer, a notebook computer, a tablet computer or a transformer tablet computer, which is not limited herein. The NFC electronic device 100 includes a reading module 110, an embedded controller 120 and a matching module 130. The embedded controller 120 is connected between the reading module 110 and the matching module 130.

The reading module 110 receives identification information transmitted from the readable component 200, and the identification information may be passwords or keys. The reading module 110 transmits data to and receives data from the readable component 200 via the NFC protocol. The readable component 200 may be a portable NFC product such as an induced chip card (such as a Visa Wave card or a PayPass card) or a watch.

The embedded controller 120 can be connected to the reading module 110 via a serial communication bus of an Inter integrated circuit to transmit or receive a control signal. The embedded controller 120 further includes a non-volatile memory (not shown), such as a read-only memory (ROM) or a flash memory which can store the identification information or the account confidential information. The embedded controller 120 has a function of outputting characters, and thus it can output a hardware signal corresponding to characters and numbers of a keyboard.

The matching module 130 can be achieved via an application program or a driving program. The matching module 130 also includes a group of recognition information corresponding to the identification information of the readable component 200, and the recognition information may be passwords or keys. Then the recognition information of the matching module 130 and the identification information are used to perform the matching authentication process. Since different readable components 200 have different identification information, the matching module 130 can identify the users by recognizing the identification information. If the matching authentication is successful, the matching module 130 searches whether required account confidential information exists in a database. If yes, the matching module 130 transmits the account confidential information to the embedded controller 120, and the embedded controller 120 outputs the hardware signal corresponding to the account confidential information to the user login screen to login in.

The user login screen may be a booting login screen of Windows operation system, a login screen of a webmail service or a social networking site such as Facebook. All screens or website screens are all within the scope of a user login screen as long as authentication information (identifications and passwords) is needed.

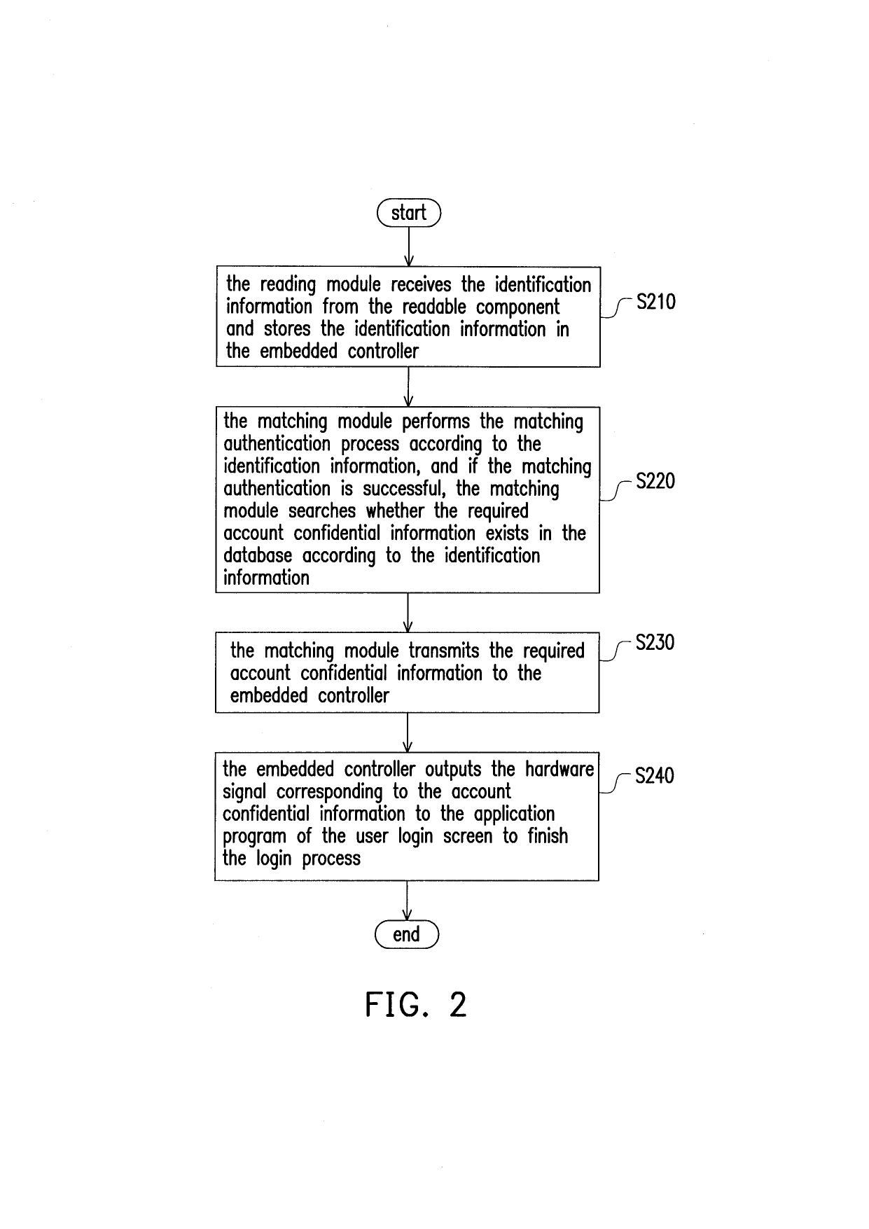

FIG. 2 is a flow chart showing steps of a login method applied to a NFC electronic device in a first embodiment. Details of the login process executed by the login system 10 are illustrated with FIG. 1B and FIG. 2.

When a user operates the NFC electronic device 100 to enter a user login screen, the login process starts. For example, if the NFC electronic device 100 is a tablet computer, when the user operates the tablet computer to surf the internet and login a social networking site, a user login screen of the social networking site is provided and the login process starts.

In step S210, the reading module 110 receives the identification information from the readable component 200. In detail, the user moves the readable component 200 close to the NFC electronic device 100, and the reading module 110 of the NFC electronic device 100 receives the identification information from the readable component 200 and stores the identification information in the embedded controller 120.

In step S220, the matching module 130 performs the matching authentication process to the identification information stored in the embedded controller 120. If the matching authentication is successful, the matching module 130 searches whether the required account confidential information exists in the database according to the identification information. It is assumed that multiple groups of the account confidential information corresponding to the identification information are stored in the database in advance, and each group of the account confidential information corresponds to different services or user login screens of the application programs. Consequently, the matching module 130 selects a group of the account confidential information meeting the user login screen from the database according to the identification information.

In step 5230, the matching module 130 transmits the selected account confidential information to the embedded controller 120. In step S240, the embedded controller 120 outputs the hardware signal corresponding to the account confidential information to the application program of the user login screen to finish the login process.

In sum, only if the user uses the readable component 200, the NFC electronic device 100 automatically searches for the account confidential information meeting the user login screen, and the embedded controller 120 of the NFC electronic device 100 automatically outputs the account confidential information. Since the user usually sets different account confidential information for login screens of different operation systems or application program services in consideration of data security and privacy, they easily forget the correspondence between each group of the account confidential information and the login screen. As a result, according to the login system and the login method in the embodiment, not only the complicated step of inputting the account confidential information does not needed, multiple groups of the account confidential information also can be integrated. It can automatically search and select the corresponding account confidential information and further simplify the operation steps of the login process.

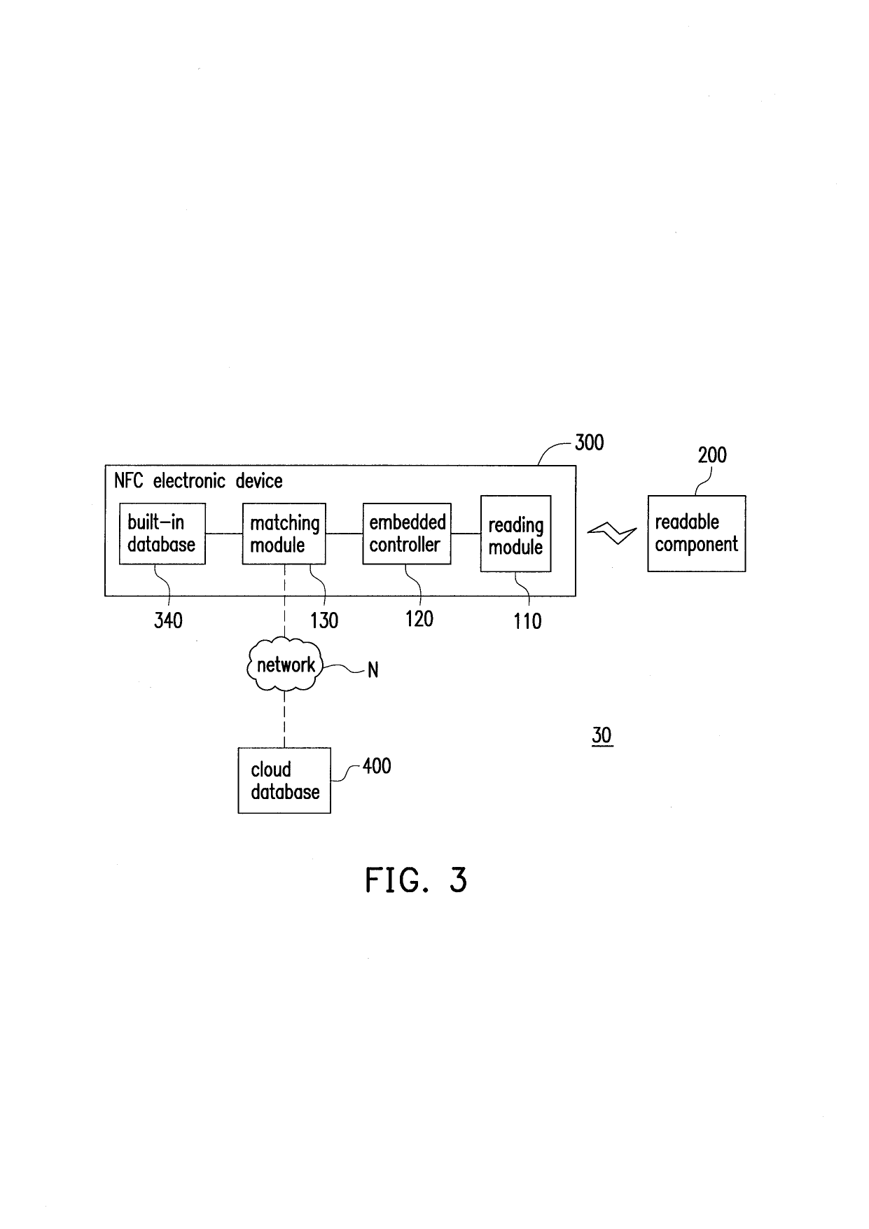

FIG. 3 is a block diagram showing a login system using a NFC electronic device in a second embodiment. In FIG. 3, the login system 30 is similar to the login system 10 in FIG. 1, and the differences therebetween are illustrated as follows.

The NFC electronic device 300 further includes a built-in database 340 connected to the matching module 130 except the reading module 110, the embedded controller 120 and the matching module 130. Moreover, the matching module 130 can be connected to a cloud database 400 via Internet N (such as Ethernet). The matching module 130 may be connected to the Internet N wiredly or wirelessly, which is not limited herein.

The built-in database 340 may include accessible memories and input/output devices configured for receiving and providing tables, lists or other data structures.

The cloud database 400 may be achieved via one or a combination of software and hardware. The software may be an application program, and the hardware may be an accessible memory or an input/output device configured for receiving and providing tables, lists or other data structures.

The matching module 130 can read or write the identification information and the corresponding groups of the account confidential information to the built-in database 340 and the cloud database 400.

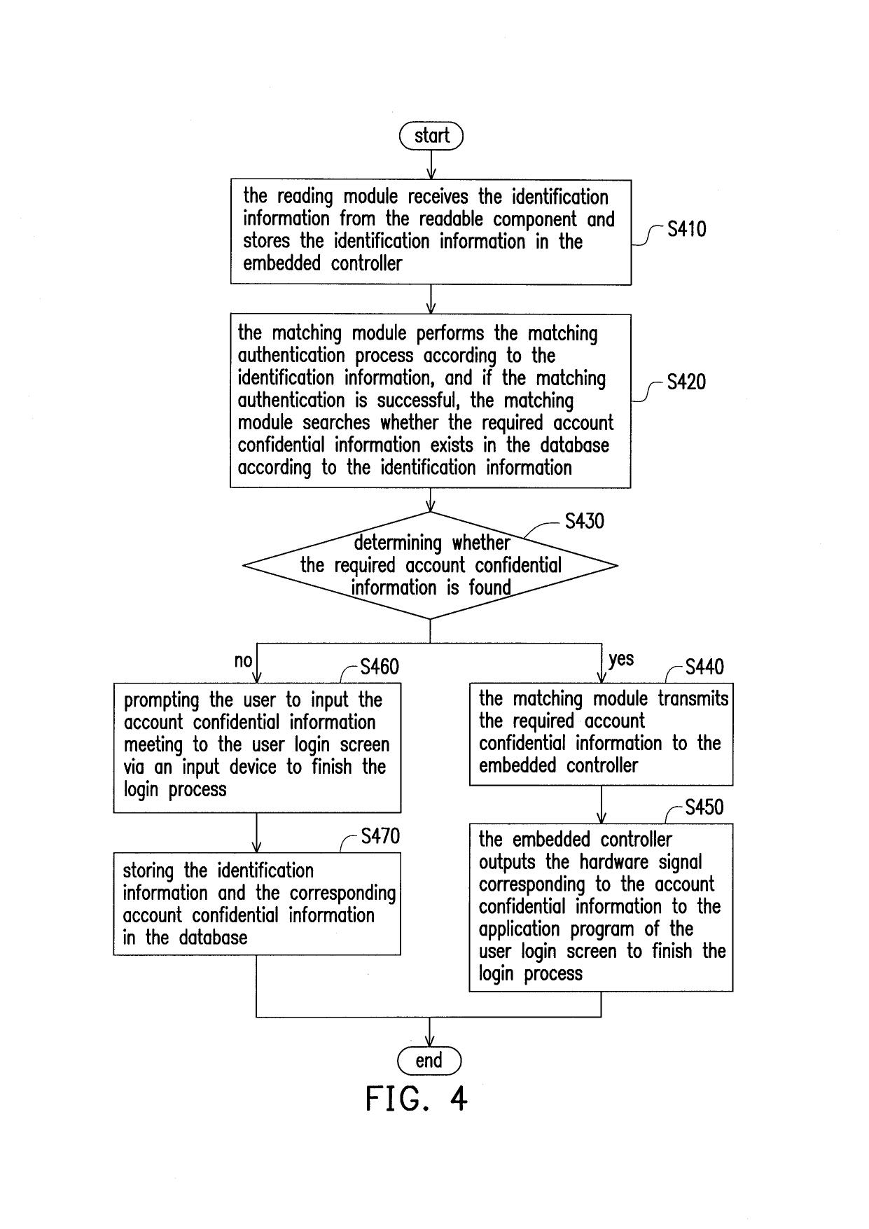

FIG. 4 is a flow chart showing steps of a login method applied to a NFC electronic device in a second embodiment. The operation steps of the login system 30 are illustrated in FIG. 4. Please refer to FIG. 3 and FIG. 4.

In step S410, the reading module 110 receives the identification information from the readable component 200 and stores the identification information in the embedded controller 120. In step S420, the matching module 130 performs the matching authentication process using the identification information stored in the embedded controller 120. If the matching authentication is successful, the matching module 130 searches whether the required account confidential information exists in the database according to the identification information. In the embodiment, the matching module 130 may search and select the account confidential information from the built-in database 340 first. If the search fails, the matching module 130 is connected to the cloud database 400 via the Internet N for a further search.

In step S430, after searching the built-in database 340 and the cloud database 400, the matching module 130 determines whether the required account confidential information is found. If yes, step S440 is executed; if no, step S460 is executed. The step S440 is similar to the step S230 and the step S450 is similar to the step S240, which is omitted herein.

In the step S460, the search of the required account confidential information fails, and the cause of search failure may be but not limited to the followings. The identification information of the readable component 200 is not stored in the built-in database 340 or the cloud database 400 (for example, the readable component 200 is used for the first time). The other cause is that the identification information of the readable component 200 is stored in the built-in database 340 or the cloud database 400, but the account confidential information corresponding to the identification information for logining the wanted service or the application program are not included in the multiple groups of the account confidential information.

Thus, when the search fails, the NFC electronic device 300 prompts the user to input the account confidential information meeting the user login screen via an input device (such as a keyboard or a touch screen). In step S470, the matching module 130 stores the identification information indentified by the readable component 200 and the inputted account confidential information in the built-in database 340 or the cloud database 400. When the user wants to login the same screen next time, the corresponding account confidential information is already stored in the built-in database 340 or the cloud database 400, and the user does not need to input manually again.

In sum, in a user login screen of various operation systems or website services, the identification function of the NFC technology applying the embedded controller can be used to execute the login process and ensure the login security and privacy. Moreover, the login system and the login method in the embodiment can not only omit the complicated step of inputting the account confidential information, but also integrate multiple groups of the account confidential information, automatically search and select the corresponding account confidential information. As a result, the operation steps of the login process are simplified.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A near field communication (NFC) electronic device, comprising:
a reading module receiving identification information transmitted from a readable component when the readable component approaches;
an embedded controller connected to the reading module and storing the identification information; and
a matching module connected to the embedded controller and performing a matching authentication according to the identification information, wherein if the matching authentication is successful, the matching module searches whether a required account confidential information exists in a database according to the identification information, and if yes, the matching module selects the required account confidential information and transmits the required account confidential information to the embedded controller,
wherein the embedded controller outputs a hardware signal corresponding to the account confidential information to an application program of a user login screen to finish a login process.

2. The NFC electronic device according to claim 1, wherein the matching module builds a plurality of the account confidential information corresponding to the identification information in the database, and the account confidential information corresponds to the user login screens of different services or the application programs.

3. The NFC electronic device according to claim 1, wherein the database further includes a cloud database, and the matching module is connected to the cloud database via the interne to access the account confidential information corresponding to the identification information.

4. The NFC electronic device according to claim 1, wherein the embedded controller is connected to the reading module via a serial communication bus to transmit or receive control signals.

5. The NFC electronic device according to claim 1, wherein the embedded controller includes a non-volatile memory to store the identification information.

6. A login system, comprising:
a readable component transmitting identification information to a NFC electronic device when the readable component approaches the NFC electronic device; and
the NFC electronic device, including:
a reading module receiving identification information transmitted from the readable component when the readable component approaches;
an embedded controller connected to the reading module and storing the identification information; and
a matching module connected to the embedded controller and performing a matching authentication according to the identification information, wherein if the matching authentication is successful, the matching module searches whether the required account confidential information exists in a database according to the identification information, and if yes, the matching module selects the required account confidential information and transmits the required account confidential information to the embedded controller,
wherein the embedded controller outputs a hardware signal corresponding to the account confidential information to an application program of a user login screen to finish a login process.

7. The login system according to claim 6, wherein the database includes a built-in database and a cloud database.

8. The login system according to claim 7, wherein the NFC electronic device includes the built-in database, the matching module is connected to the built-in database, and the matching module searches the account confidential information in the built-in database.

9. The login system according to claim 7, wherein the login system includes the cloud database, the matching module is connected to the cloud database via internet, and the matching module searches the account confidential information in the cloud database.

10. A login method applied to a NFC electronic device, the login method comprising following steps:
receiving identification information from a readable component via a reading module and storing the identification information in an embedded controller of the NFC electronic device;
performing a matching authentication according to the identification information via a matching module, and if the matching authentication is successful, searching whether required account confidential information exists in a database according to the identification information;
selecting the account confidential information and transmitting the account confidential information to the embedded controller via the matching module; and
outputting a hardware signal corresponding to the account confidential information to an application program of a user login screen via the embedded controller to finish a login process.

11. The login method according to claim 10, wherein the login method further includes:
building the account confidential information in the database according to the identification information via the matching module and storing the account confidential information corresponding to the identification information in the database, wherein the account confidential information corresponds to the user login screens of different services or the application programs.

12. The login method according to claim 10, wherein the login method further includes:
providing a cloud database, wherein the matching module is connected to the cloud database via the internet to access the account confidential information corresponding to the identification information.
